(19) United States
(12) Patent Application Publication
(10) Pub. No.: US 2026/0254000 A1
(43) Pub. Date: Aug. 27, 2026

(54) THERMOCAPACITIVE HEAT PUMPS WITH ELECTRICAL ENERGY STORAGE

(71) Applicant: Alliance for Energy Innovation, LLC, Golden, CO (US)

(72) Inventor: Nelson Alexander Marvin JAMES, Loveland, CO (US)

(21) Appl. No.: 19/550,470

(22) Filed: Feb. 26, 2026

Related U.S. Application Data
(60) Provisional application No. 63/763,629, filed on Feb. 26, 2025.
(60) Provisional application No. 63/867,353, filed on Aug. 20, 2025.

(51) Int. Cl. H01M 10/663; F25B 30/00

(52) U.S. Cl. CPC H01M 10/663; F25B 30/00

(57) ABSTRACT

Thermocapacitive heat pumps (TCHP) as an alternative to traditional vapor compression heat pumping cycles are described. Two primary embodiments of TCHPs: a liquid regenerated TCHP and a mass regenerated TCHP. The two embodiments differ in the medium used to transfer heat between the supercapacitive cells, but both utilize a voltage source to generate a heat differential which may be utilized to replace traditional heat pumps.

### CROSS-REFERENCE TO RELATED APPLICATIONS

This application claims priority from U.S. Provisional Patent Application No. 63/763,629 filed on Feb. 26, 2025 and U.S. Provisional Patent Application No. 63/867,353 filed on Aug. 20, 2025, the contents of which are incorporated herein by reference in their entirety.

### CONTRACTUAL ORIGIN

This invention was made with government support under Contract No. DE-AC36-08GO28308, awarded by the Department of Energy. The government has certain rights in this invention.

### BACKGROUND

The buildings'sector accounts for more than 40% of the U.S. primary energy usage, and nearly half of building energy usage is related to space cooling and heating, water heating, and refrigeration. Heat pumps are widely used to provide cooling and heating. Most heat pumps are single function devices for moving or converting heat. A heat pump is typically the single greatest energy user in a building. Conventional strategies for improving performance and reducing the energy usage of these devices typically consist of mechanical equipment upgrades and/or new refrigerants. However, these have not resulted in significant changes or improvement in heat pumps. Thus, there remains a need for improved heat pumps.

### SUMMARY

An aspect of the present disclosure is a device including a supercapacitive cell, a voltage source configured to supply a voltage to the supercapacitive cell, a first reservoir, a second reservoir, a first heat exchanger configured to release heat, a second heat exchanger configured to absorb heat, and a fluid circuit positioned through the supercapacitive cell, the first reservoir, the second reservoir, the first heat exchanger, and the second heat exchanger, in which a fluid is present is the fluid circuit, and when the voltage is applied to the supercapacitive cell the supercapacitive cell is configured to generate a temperature difference between the first reservoir and the second reservoir. In some embodiments, the device also includes a pump, in which the pump is configured to pump the fluid through the fluid circuit. In some embodiments, the supercapacitive cell includes a supercapacitor. In some embodiments, the supercapacitive cell is configured to heat a portion of the fluid when the voltage is applied, resulting in a heated fluid, and the heated fluid is configured to flow into the first reservoir. In some embodiments, the supercapacitive cell is configured to cool a portion of the fluid when the voltage is reduced, resulting in a cooled fluid, and the cooled fluid is configured to flow into the second reservoir. In some embodiments, the fluid includes water. In some embodiments, the device includes a second supercapacitive cell, in which the supercapacitive cell is a first supercapacitive cell, and the first supercapacitive cell and the second supercapacitive cell are arranged in series. In some embodiments, the first heat exchanger is configured to release heat to a building. In some embodiments, the second heat exchanger is configured to absorb heat from a building.

An aspect of the present disclosure is a method including operating a thermocapacitive heat pump, in which the thermocapacitive heat pump includes a supercapacitive cell, a voltage source configured to supply a voltage to the supercapacitive cell, a first reservoir, a second reservoir, a first heat exchanger configured to release heat, a second heat exchanger configured to absorb heat; and a fluid circuit positioned through the supercapacitive cell, the first reservoir, the second reservoir, the first heat exchanger, and the second heat exchanger, in which a fluid is present is the fluid circuit, and the operating comprises applying a voltage to the supercapacitive cell resulting in the supercapacitive cell generating a temperature difference between the first reservoir and the second reservoir.

An aspect of the present disclosure is a device including a plurality of supercapacitive cells, a voltage source configured to supply a voltage to the supercapacitive cells, a first fluid circuit connecting at least one of the supercapacitive cells to a first heat exchanger, and a second fluid circuit connecting at least one of the supercapacitive cells to a second heat exchanger, in which when the voltage is applied to the supercapacitive cells the supercapacitive cells are configured to generate a temperature difference between the first fluid circuit and the second fluid circuit. In some embodiments, the device also includes a first pump, in which the pump is configured to pump the fluid through the first fluid circuit. In some embodiments, the device also includes a second pump, in which the pump is configured to pump the fluid through the second fluid circuit. In some embodiments, the plurality of supercapacitive cells comprise a shaft configured to align the supercapacitive cells and an actuator configured to move the shaft. In some embodiments, when a voltage is applied the plurality of supercapacitive cells are configured to direct heat in a first direction resulting in a heated first fluid circuit, and the first heat exchanger is configured to release heat from the first fluid circuit. In some embodiments, the first exchange is in thermal communication with an interior of a building. In some embodiments, the fluid comprises water or a refrigerant. In some embodiments, the plurality of thermocapacitive cells are arranged in series in a channel with spacing between each thermocapacitive cell to facilitate a temperature gradient formation across the channel. In some embodiments, the channel comprises a first end and a second end, the first fluid circuit is in thermal communication with the first end, and the second fluid circuit is in thermal communication with the second end. In some embodiments, the second exchanger is in thermal communication with a building interior, the second heat exchanger is configured to absorb heat and transfer it to the second fluid circuit, the second fluid circuit is in thermal communication with the supercapacitive cells.

### BRIEF DESCRIPTION OF THE DRAWINGS

Some embodiments of the present disclosure are illustrated in the referenced figures of the drawings. It is intended that the embodiments and figures disclosed herein are to be considered illustrative rather than limiting.

FIG. 1 illustrates a schematic of a liquid regenerated thermocapacitive heat pump (TCHP), according to some aspects of the present disclosure.

FIG. 2 illustrates a schematic showing the assembly of a prototype liquid regenerated TCHP, according to some aspects of the present disclosure.

FIGS. 3A-F illustrate data generated during the testing of the liquid regenerated TCHP prototype: FIG. 3A: example liquid reservoir temperature evolution generated during the testing of the liquid regenerated TCHP prototype under applied currents of approximately 200 mA and liquid flow producing a utilization factor of approximately 2.0; FIG. 3B: variation in measured temperature drop in the liquid reservoir in relation to various utilization factors for an applied current of 200 mA; FIG. 3C: changes in the measured electrical storage density and the thermal power density under varying applied currents at a constant utilization factor of 1.5; FIG. 3D: changes in the measured cooling COP and the total cooling load under varying applied currents at a constant utilization factor of 1.5; FIG. 3E: plot of voltage vs. cell capacitance during a cycle of system operation at various applied currents; FIG. 3F: side view of the TCHP fluid regenerator cell fixture closed (top) and with the fixture top removed (bottom), according to some aspects of the present disclosure.

FIG. 4 illustrates a solid regenerated TCHP with multiple supercapacitive cells, according to some aspects of the present disclosure.

FIGS. 5A-F illustrates: 5A comparison of modeled unit cell performance parameters with calorimetry data (each parameter normalized with each averaged experimental value); 5B ΔTₛₚₐₙ of the cascaded cell system as a function of the number of cells (N_{cell}) and cycles (N_{cycle}) at a substantially fixed j of approximately 12.5 A m⁻²; 5C time evolution of ΔTₛₚₐₙ and temperature of the cell; 5D temperature distribution of the cascaded cells at the different N_{cycle}; 5E ΔTₛₚₐₙ and energy storage density (ED) as a function of volumetric heating capacity (\dot{q}ᵥ); and 5F predicted COP/COP_{Carnot} and \dot{q}ᵥas a function of j, according to some aspects of the present disclosure.

### REFERENCE NUMBERS

100 . . . liquid regenerated thermocapacitive heat pump (TCHP)
105 . . . supercapacitive cells
110 . . . heater
115 . . . cooler
120 . . . pump
125 . . . first reservoir
130 . . . second reservoir
135 . . . voltage source
140 . . . fluid circuit
145 . . . fluid
150 . . . case
155 . . . gasket
160 . . . bronze wool
165 . . . supercapacitors
200 . . . solid regenerated TCHP
205 . . . actuator
210 . . . fluid circuit
215 . . . heat exchanger
220 . . . pump
225 . . . container
230 . . . shaft
235 . . . supercapacitive cell
240 . . . fluid circuit
245 . . . fluid

### DETAILED DESCRIPTION

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

Among other things, the present disclosure relates to thermocapacitive heat pumps (TCHP) as an alternative to traditional vapor compression heat pumping cycles. The present disclosure includes two primary embodiments of TCHPs: a liquid regenerated TCHP and a mass regenerated TCHP. The two embodiments differ in the medium used to transfer heat between the supercapacitive cells.

Among other things, the present disclosure relates to TCHPs a potential alternative to traditional vapor compression heat pumping cycles. Supercapacitors are energy storage devices that have gained popularity for their high-power capabilities and high storage efficiencies. When charged, these devices bind ions to the surface of their electrodes. During this charging process heat will be absorbed or released depending on the nature of the materials used in the cell's electrolyte and electrodes. This leads to an increase or decrease in the temperature of the cell. Leveraging temperature changes during charge/discharge and the inherit energy storage capabilities of thermocapacitive devices, multifunctional equipment can be created to efficiently provide heating and cooling to buildings while simultaneously adding electrical energy storage capacity to the buildings. Supercapacitive cells can produce improved temperature changes by using approximately 1 M LiCl in deionized (DI) water. This is because of the enhanced entropy change and reversible heat generation of the cells. The prototyped cells of the present disclosure include a cellulose separator, activated carbon electrodes, and polymer pouch cell case. The polymer pouch cell case substantially minimizes the heat loss to the ambient. The microstructures of the cells have sufficient porosity (approximately 60%) which could enhance the species' transport. Calorimetric experiments showed a maximum of approximately 2.7° C. temperature span when the cell maintained adiabatic conditions. This temperature span is the highest reported value among the lab-fabricated supercapacitors having less than approximately 10 F. During operation of the heat pumping device, thermal recuperation may be required to allow for temperature lifts greater than the adiabatic temperature change of an individual cell. This recuperation can be achieved in numerous ways such as the flow of fluid or solid mass over the thermocapacitive elements or through the direct movement and thermal interaction of the thermocapacitive elements with each other. Multiple cells can be arranged in a channel with space in between each cell to allow a temperature gradient to form across the cell assembly during operation. In general, the timing of the charging and discharging of the cells as well at the timing of the regeneration stages may need to be optimized to maximize the thermal performance of the heat pumping device. Upon charging, the cells may undergo a change in temperature and voltage. Next a thermal regeneration method is used to carry heat to or from one side of the assembly of cells. Following this, the cells may be discharged by changing the temperature and voltage of the cells in the opposite direction. Finally, the regeneration method may be used to carry heat to or from the other side of the cell assembly. This process may be repeated to generate a temperature gradient that can be used for heat pumping. When energy storage is needed the cells in the thermocapacitive heat pump can function as an electrical energy storage device where energy can be stored in the capacitive elements and discharged at a later time. This may prove useful for load shifting and other grid interactive services which can help further reduce energy cost, carbon emissions, and increase energy resilience of buildings.

Some embodiments of the present disclosure include a cellulose separator, activated carbon electrodes, and polymer pouch cell case. The polymer pouch cell case substantially minimizes the heat loss to the ambient. The microstructures of the cells have sufficient porosity (approximately 60%) which could enhance the species' transport. Calorimetric experiments showed a maximum of approximately 2.7° C. temperature span when the cell maintained adiabatic conditions. This temperature span is the highest reported value among the lab-fabricated supercapacitors having less than approximately 10 F. During operation of the heat pumping device, thermal recuperation may be required to allow for temperature lifts greater than the adiabatic temperature change of an individual cell. This recuperation can be achieved in numerous ways such as the flow of fluid or solid mass over the thermocapacitive elements or through the direct movement and thermal interaction of the thermocapacitive elements with each other. Multiple cells can be arranged in a channel with space in between each cell to allow a temperature gradient to form across the cell assembly during operation. In general, the timing of the charging and discharging of the cells as well at the timing of the regeneration stages may need to be optimized to maximize the thermal performance of the heat pumping device. Upon charging, the cells may undergo a change in temperature and voltage. Next a thermal regeneration method is used to carry heat to or from one side of the assembly of cells. Following this, the cells may be discharged by changing the temperature and voltage of the cells in the opposite direction. Finally, the regeneration method may be used to carry heat to or from the other side of the cell assembly. This process may be repeated to generate a temperature gradient that can be used for heat pumping. When energy storage is needed the cells in the thermocapacitive heat pump can function as an electrical energy storage device where energy can be stored in the capacitive elements and discharged at a later time. This may prove useful for load shifting and other grid interactive services which can help further reduce energy cost, carbon emissions, and increase energy resilience of buildings.

Supercapacitors are energy storage devices that have high power capabilities and high storage efficiencies. When charged, supercapacitors bind ions to the surface of their electrodes. During this charging process heat may be absorbed or released depending on the nature of the materials used in the cell's electrolyte and electrodes. This may lead to an increase or decrease in the temperature of the cell. Leveraging temperature changes during charge and discharge and the inherent energy storage capabilities of thermocapacitive devices, multifunctional equipment can be created to efficiently provide heating and cooling to buildings while simultaneously adding electrical storage capacity to the buildings.

Supercapacitors, also known as electric double layer capacitors (EDLCs), are electrochemical energy storage devices that utilize electric fields and high surface area electrodes to separate charge and store energy in an enclosed cell. Thermocapacitive cycles are systems that incorporate supercapacitors into thermal processes to exploit voltage-temperature relationships within the cells, similar to thermogalvanic effects. Previously investigated thermocapacitive cycles have primarily been power generation devices. In these systems the supercapacitive cell is heated and cooled before charging and discharging. As a result of these temperature changes the equilibrium voltage of the cell can be altered, and net positive work can be extracted from the cell.

The central component of the TCHP is the supercapacitive cell. During charging, electrostatic forces bind ions to the electrode surface causing a change in ionic configuration entropy. This can lead to an increase or decrease in cell temperature based on the composition of the cell. When discharging the cell, the desorption of ions leads to a temperature change opposite of that in the charging process. Depending on the composition of electrode materials, rapid redox reactions between the electrode and ionic species can be involved in capacitive heating and cooling

The change in temperature of supercapacitive cells during charging and discharging is based on multiple factors including the cell specific surface area, the heat of reaction, the specific heat capacity of the cell, and the mass of the cell. The specific surface area may determine the number of ions that can be stored in each electrode. The heat of reaction may influence the heat released or absorbed for each mole of ions separated. Specific heat capacity and cell mass will determine how the cell temperature changes as heat is absorbed or released by the cell. The magnitudes of the cell temperature changes reported in literature were also influenced by cell operating conditions including applied currents and cell temperatures which will impact resistance-based aspects of cell performance.

In some embodiments, during the operation a TCHP of the present disclosure, thermal recuperation may be required to allow for temperature lifts greater than the adiabatic temperature change of an individual cell. This recuperation may be achieved in numerous ways such as the flow of fluid or solid mass over the thermocapacitive elements or through the direct movement and thermal interaction of the thermocapacitive elements with each other. Multiple TCHPs may be arranged in a channel with space between each cell to allow a temperature gradient to form across the cell assembly during operation. In general, the timing of the charging and discharging of the cells as well at the timing of the regeneration stages may be scheduled to attempt to maximize the thermal performance of the TCHP. Upon charging, the cells will undergo a change in temperature. Next a thermal regeneration method may be used to carry heat to or from one side of the assembly of cells. Following this, the TCHP may be discharged changing the temperature of the cells in the opposite direction. Finally, the regeneration method is used to carry heat to or from the other side of the cell assembly. This process may be repeated to generate a temperature gradient that can be used for heat pumping.

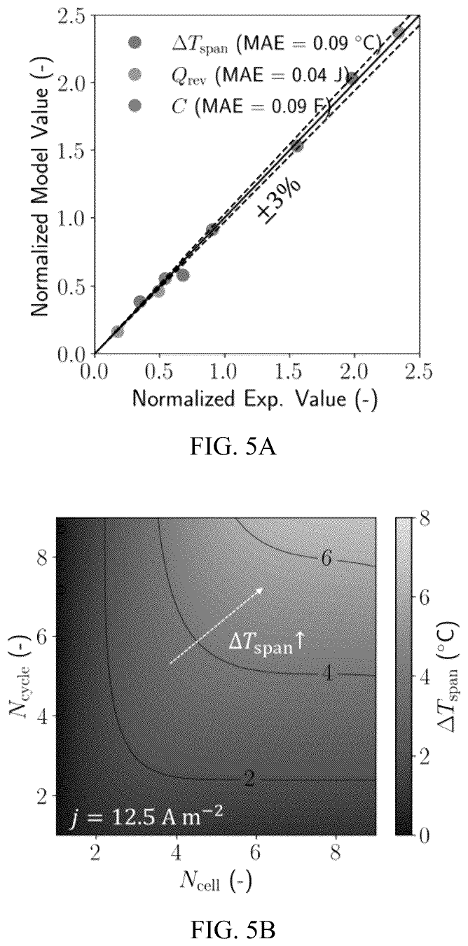

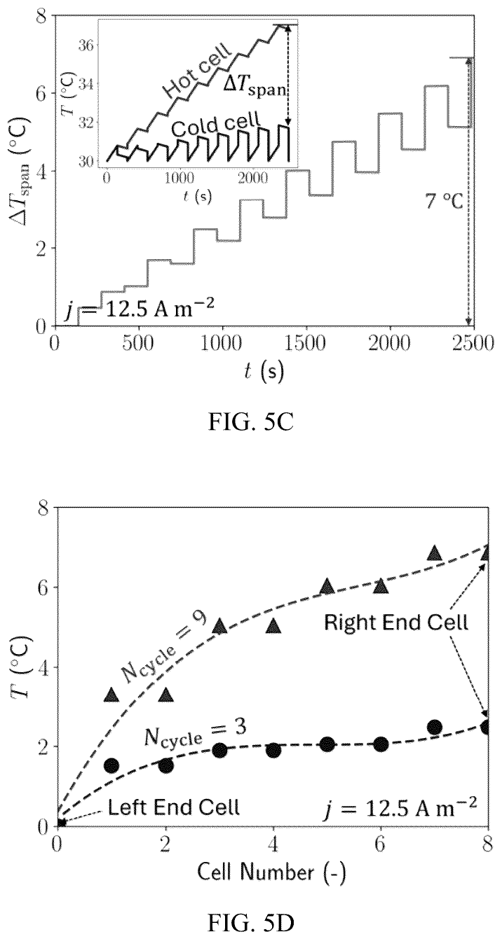

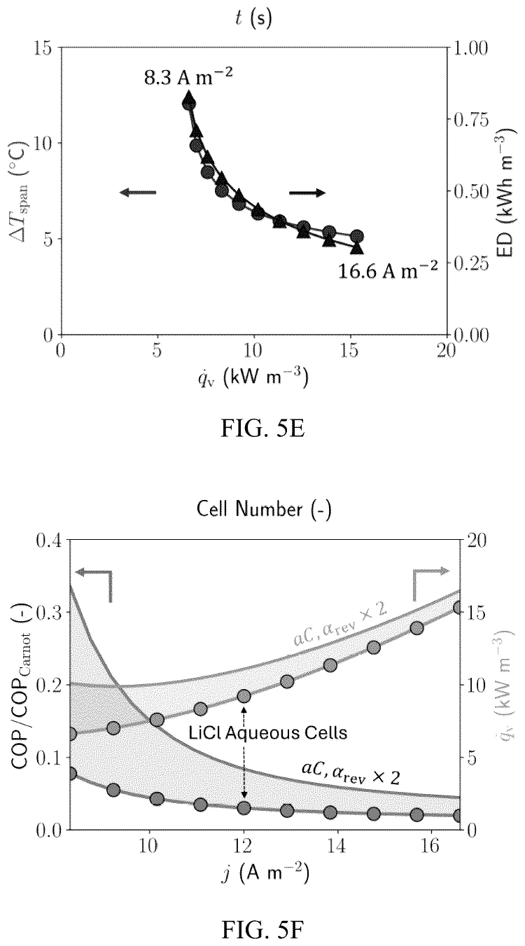

schematic of a liquid regenerated TCHP 100 is shown in FIG. 5. The liquid regenerated TCHP 100 may include at least one supercapacitive cell 105 connected to a voltage source 135. A fluid 145 in a fluid circuit 140 may be in thermal contact with the supercapacitive cell 105 and a heater 110 (for releasing heat from the liquid regenerated TCHP 100) and a cooler 115 (for inputting heat into the liquid regenerated TCHP 100). At least two liquid pumps 120 may be used to drive fluid circulation in the fluid circuit 140. A first reservoir 125 and a second reservoir 130 may both be connected to the fluid circuit 140 and capable of holding the fluid for a period of time when needed. The first reservoir 125 and/or the second reservoir 130 may be insulated to reduce heat loss.

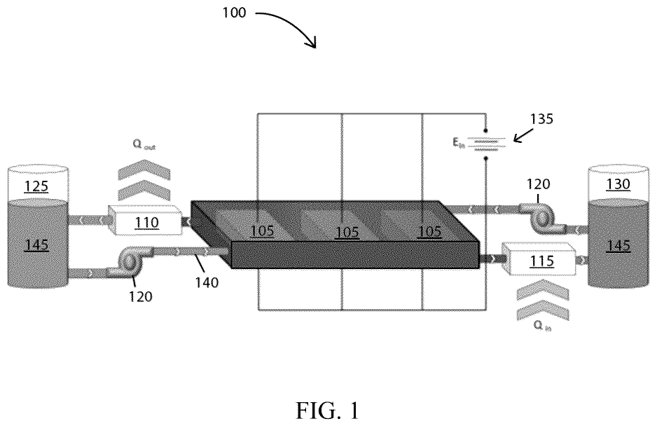

In some embodiments, the process for operating a liquid regenerated TCHP 100 of the present disclosure includes first applying an electric potential (provided by a voltage source 135) to the supercapacitive cells 105. Depending on the materials used in the supercapacitive cells 105 they will either experience an increase or decrease in temperature. Next, the process may include transferring a mass across the supercapacitive cells 105 in a single direction. In the liquid regenerated TCHP 100 shown in FIG. 1, this mass may be a fluid 145 such as water through a fluid circuit 140 that makes thermal contact with the supercapacitive cells 105. During the transferring the thermal energy produced by the temperature change in the thermocapacitive cells 105 may be transferred to the fluid in the fluid circuit 140. Next, the process may include discharging the voltage from the thermocapacitive cells 105. This may lead to the opposite of the previous temperature change that occurred during the charging process. To increase system efficiency this voltage can be recovered and stored in the voltage source 135 for the next voltage application cycle. If the fluid circuit 140 consists of multiple channels run in parallel, then the voltage discharged from one set of supercapacitive cells 105 can go into charging the other supercapacitive cells 105. Next, the process may include transferring the fluid of the fluid circuit 140 across the supercapacitive cells 105 in the opposite direction. Finally, in some embodiments, the process may be repeated. The repeated coordination of cell charge/discharge with mass transfers through the supercapacitive cells 105 generates a temperature gradient across the supercapacitive cells 105 that can be used for pumping heat (which may be removed from the liquid regenerated TCHP 100 via a heater 110).

In some embodiments, when heat pumping is not required, the supercapacitive cells 105 can still be used for electrical energy storage. The liquid regenerated TCHP 100 may operate as a cyclical device to provide heating and cooling. The supercapacitive cells 105 may be coupled with heat transfer processes to drive the movement of heat from one side of the liquid regenerated TCHP 100 to the other.

In some embodiments, a liquid regenerated TCHP 100 may include an electrochemical capacitor and at least one thermoelectric generators (TEGs) (not shown in FIG. 1). A calorimeter housing may be used to measure heat generation (not shown in FIG. 1).

As shown in FIG. 1, in some embodiments, hot and cold side heat exchangers (i.e., a heater 110 and a cooler 115) are placed at opposite ends of the fluid channel housing/case 150 the supercapacitive cells 105 to harness the warmer fluid leaving the stack of supercapacitive cells 105 for heating (via the heater 110) and the cooler fluid leaving the supercapacitive cells 105 for cooling (via the cooler 115).

During operation of the liquid regenerated TCHP 100, the supercapacitive cells 105 are first adiabatically discharged. The change in supercapacitive cell 105 temperature during discharging will depend on the material composition of the supercapacitive cells 105. After adiabatically discharging, the fluid 145 flows through the fluid circuit 140 in one direction. This moves the effect of the supercapacitive cell's 105 heating or cooling to one end of the fluid circuit 140. Next, the supercapacitive cells 105 are adiabatically charged. The opposite temperature change observed during the discharging process will be induced within the supercapacitive cells 105. After charging the fluid 145 will flow in the opposite direction through the fluid circuit 140. Repeating this process will lead to the development of a temperature gradient across the fluid circuit 140 that can be harnessed for heat pumping. In an attempt to maximize the efficiency of the liquid regenerated TCHP 100, the electrical energy released during the discharge process may be recovered and utilized to reduce the energy consumption required during cell charging provided by the voltage source 135. This may include using high efficiency power electronics and DC-DC converters in conjunction with high cell efficiencies.

Similar to electrocaloric devices, the temperature change in the liquid regenerated TCHP 100 can be induced through the application of an electrical potential using the voltage source 135. This may greatly simplify the construction of future heat pumping devices in comparison to other caloric devices which may require high magnetic fields or uniaxial stresses. The voltage requirements for the liquid regenerated TCHP 100 may be significantly less than those needed for typical electrocaloric devices which can be in kilovolts and higher ranges. These high voltages often necessitate the need to use dielectric fluids (e.g., oil, benzene) as heat transfer fluids. Dielectric fluids generally have less desirable heat transfer characteristics than water and can reduce the performance of the heat pumping process. Electrocaloric materials can behave as capacitors and store energy during the application and release of electric fields. This stored energy can be up to 110 J cm⁻³. Because supercapacitors are inherently energy storage devices, supercapacitive cells 105 have the potential to provide greater electrical energy storage densities as high as 215-317 J cm⁻³.

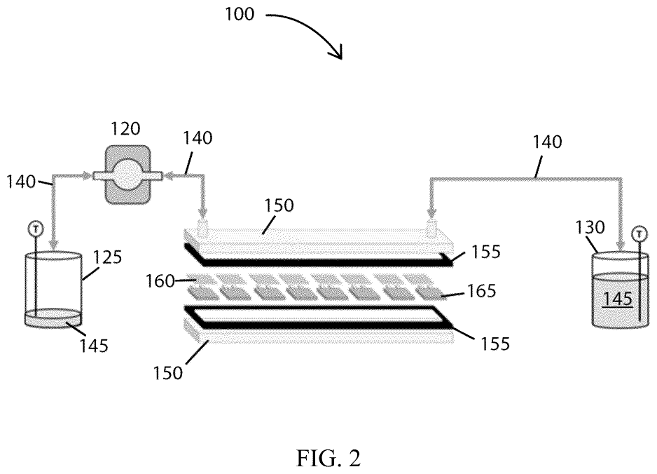

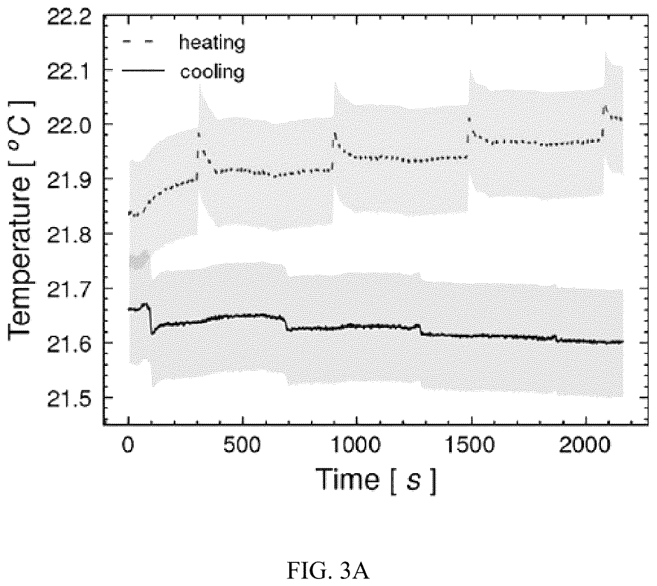

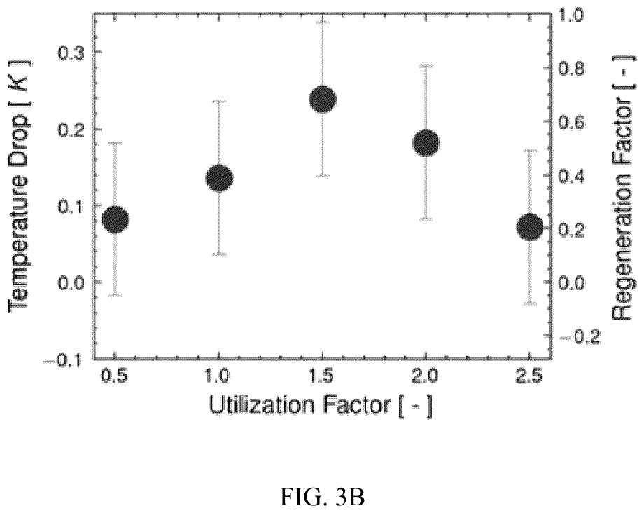

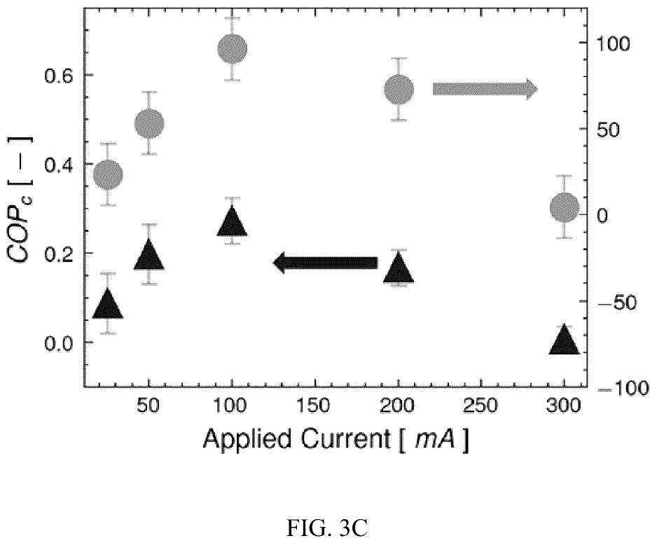

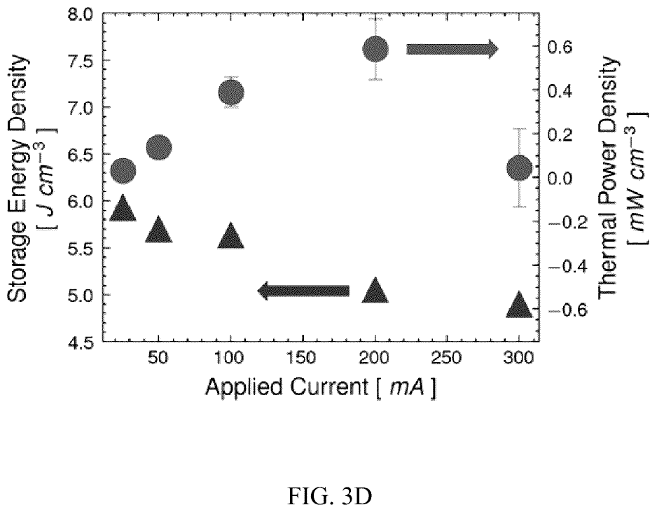

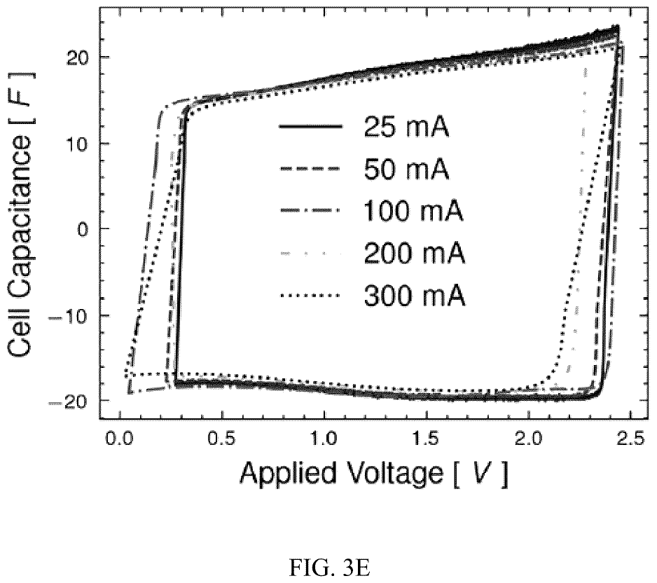

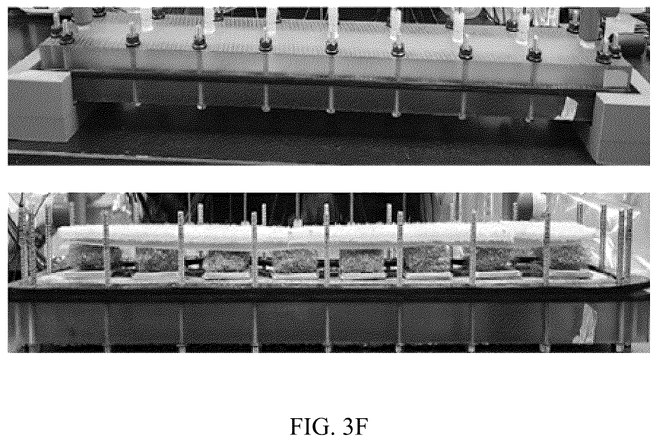

A proof-of-concept device was constructed to evaluate the heat pumping potential of the liquid regenerated TCHP 100, as shown in FIG. 2. A photo of this prototype is shown in FIG. 3F. The case 150 top and bottom were constructed of polycarbonate sheets and were used in conjunction with the gaskets 155 to make a channel for the fluid circuit 140 for the device while minimizing heat loss. Supercapacitors 165 were substantially evenly spaced throughout the case 150 with tabs with foil sheets used to extend the cell tabs to the exterior of the case 150 for electrical connections. Plastic tubing was used to connect the respective components and were wrapped in insulation. Plastic bottles were used as water reservoirs and were wrapped in inch thick fiberglass insulation. The liquid regenerated TCHP 100 was operated such that a first reservoir 125 attached to the pump 120 would undergo heating while a second reservoir 130 would be cooled. Eight commercial supercapacitive cells 105 with planar form factors were placed between two polycarbonate blocks (i.e., the case 150) to help maintain an adiabatic environment. The supercapacitors 165 utilized carbon electrodes and a propylene carbonate-based electrolyte. Rubber gaskets 155 were used to help create a flow channel between the blocks and allow the cell terminal leads to pass through to the exterior of the fixture. Bronze wool 160 was layered on top of the supercapacitors 165 to increase heat transfer between the fluid circuit 140 and the supercapacitive cells 105 and ensure that the fluid circuit 140 would have an unobstructed path to flow around the supercapacitive cells 105. A reversible pump 120 was used to transfer fluid 145 back and forth through the fluid circuit 140 between two plastic liquid reservoirs. The liquid 145 reservoirs (125 and 130) were encased in insulation during the testing to minimize any heat transfer to the surrounding environment. Rather than using a hot and cold heat exchanger (i.e., heater 110 and cooler 115) to transfer heat between a sink and source temperature respectively, the proof-of-concept system operated as a batch process. The fluid in the fluid circuit 140 was cycled through the cell fixture between two reservoirs (125 and 130) to gradually build up a temperature difference between the reservoirs (125 and 130). Resistive temperature detector (RTD) probes were used to record the temperature of each reservoir (125 and 130). Plastic tubes wrapped in foam insulation were used to connect the respective components. A multichannel potentiostat was used to apply prescribed currents and act as a voltage source 135 to the cells.

To create the prototype shown in FIG. 2, eight supercapacitor cells (EDLCs) were acquired from KYOCERA to serve as the supercapacitive cells 105 within the prototype heat pump (PrizmaCap-SCPC34B206SNAHT). These supercapacitive cells 105 had a rated capacitance of approximately 20 F (cross-sectional area of about 00 cm² ) and an energy storage capacity of about 0.017 W-hr. The supercapacitive cells 105 utilized activated carbon electrodes, a propylene carbonate-based electrolyte, and a paper separator. A custom approximately 66.04 cm×approximately 9.52 cm (about 26 inches by about 3.75 inches) case 150 made of polycarbonate endplates and buna-N rubber gaskets 155 was fabricated to house the supercapacitive cells 105 and form a fluid 145 channel within the case 150 for the fluid circuit 140 to facilitate the liquid 145 regeneration. The polycarbonate blocks were approximately 1.9 cm (about 0.75 inches) thick, and the buna-N rubber gaskets 155 were each approximately 0.31 cm (about 0.125 inches) thick. Twenty-two bolts were used to compress the case 150 to hold the supercapacitive cells 105 in place and contain the liquid. The supercapacitors 165 were spaced evenly throughout the length of the case 150. Plastic tubing with approximately 6.35 mm (¼ inch) outer diameter and plastic tube adapters were used to form the hydronic connections between the cell fixture to other system components. The tubing was wrapped in foam insulation. A reversible voltage controlled peristaltic pump (Langer Instruments L100-1S-2) was used to circulate the liquid 145 through the liquid regenerated TCHP 100. Each supercapacitive cell 105 (i.e., each supercapacitor 165 and bronze woold 160) was connected to a potentiostat interface (Gamry Instruments 1010B) to control charging and discharging. The potentiostats logged the voltage and current for each cell at one second intervals. Two PT1000 RTD probes (Phidgets Inc. TMP4110_0) were inserted into the fluid 145 in the reservoirs (125 and 130). A digital scale (McMaster-Carr 1863T111) was used to measure the mass of the fluid 145 in the reservoirs (125 and 130).

Before the start of each test using the prototype shown in FIG. 2, water (i.e. a fluid 145) was pumped through the case 150 to ensure a uniform temperature throughout the flow channel. Deionized water measuring approximately 100 mL was placed in each reservoir (125 and 130) at the beginning of each test. The supercapacitive cells 105 were set to a substantially charged state before starting a test. The supercapacitive cells 105 were first substantially fully discharged at a prescribed current. After discharging, the fluid 145 was pumped (using pump 120) through the channel inside the case 150 in one direction at an average mass flow rate of 0.35 g s^{31 1}. The duration of the pumping was set to achieve desired utilization factors, ranging from about 0.5 to about 2.5. The utilization factor relates the thermal capacitance of the fluid 145 flowing through the liquid regenerated TCHP 100 to the thermal capacitance of the solid elements within the liquid regenerated TCHP 100 e. Changes in the utilization factor have been shown to impact the thermal performance of liquid regenerated solid state heat pumps. In this present disclosure, the solid elements (i.e., the supercapacitive cells 105) were taken as the supercapacitors 165 and the bronze wool 160. The exact composition of the commercial supercapacitor 165 used in the prototype shown in FIG. 2 was unknown so an estimated specific heat capacity value of 1290 J kg⁻¹ K⁻¹ was used corresponding to the value calculated for the pouch supercapacitors 165. After flowing through the case 150 to achieve the desired utilization factor, the pump 120 was stopped. Next, the supercapacitive cells 105 were substantially charged at the same current as the discharging process. After the charging process, the fluid 145 was then pumped (using pump 120) in the opposite direction to move an equal amount of fluid 145 through the case 150 as the initial flow direction. The discharge-flow-charge-flow process constituted a single cycle of the liquid regenerated TCHP 100. For each test condition the liquid regenerated TCHP 100 was run through four cycles. The reservoir (125 and 130) water (i.e., fluid 145) temperatures were continually measured throughout the entire process.

Results from the respective tests are illustrated in FIGS. 3A-F. The first series of tests consisted of cycling the cells at a substantially constant current of approximately 200 mA while varying the utilization factor of the fluid 145 regeneration. Temperatures measured during these tests are shown in FIG. 3A. The regeneration factor of the liquid regenerated TCHP 100 prototype (as shown in FIG. 2) was calculated using ΔTᵣₑₛ/ΔT_{cell}, where ΔT_{cell} is the adiabatic temperature drop of the supercapacitive cell 105 and ΔTᵣₑₛ is the temperature drop of the cooling reservoir 130. ΔT_{cell} at approximately 200 mA was estimated by wrapping the supercapacitive cell 105 in insulation with a temperature probe affixed to the surface of the supercapacitive cell 105 and then cycling the supercapacitive cell 105. The ΔT_{cell} was approximately 0.35 K for the cell discharge process. A maximum temperature drop of about 0.24 K was measured in the cooling reservoir 130 at a utilization factor of about 1.5 for the prototype system as shown in FIG. 2 at approximately 200 mA applied current (using voltage source 135) (see FIG. 3B). Simultaneously a temperature rise of about 0.33 K was measured in the heating reservoir 125 (see FIG. 3B). The presence of the uninsulated pump 120 and significantly longer tubing between the supercapacitive cell 105 fixture and the heating reservoir 125 resulted in increased heat losses on the heating side of the prototype device shown in FIG. 2. As such the cooling reservoir 130 was used to characterize the thermal performance of the liquid regenerated TCHP 100.

As shown in FIGS. 3C-D, next series of tests investigated the impact of applied currents on the heat pumping and energy storage performance of the prototype liquid regenerated TCHP 100. Cycling currents of about 25, about 50, about 100, about 200, and about 300 mA were provided to the supercapacitive cells 105 while using a constant utilization factor of approximately 1.5 for the liquid 145 regeneration. The total cooling load was calculated using the mass of water (i.e., the fluid 145 used in this exemplary test) in the liquid reservoir 130 in conjunction with the reservoir 130 temperature difference at the start and end of the test. A maximum cooling load measuring 96.4 J was observed at an applied current of about 100 mA. The decrease in cooling load at higher and lower currents could be attributed to increased ohmic heating and increased heat losses to the ambient, respectively. The COP_{c} of the liquid regenerated TCHP 100 prototype as shown in FIG. 2 was calculated using Q_{c}/Wₙₑₜ, where Q_{c} the measured cooling load and Wₙₑₜ is the net work input to the supercapacitive cells over the four cycles. A maximum COP_{c} of approximately 0.27 was measured at an applied current of about 100 mA (as shown in FIG. 3C).

As shown in FIG. 3D, the energy storage density of the liquid regenerated TCHP 100 was calculated using the average voltage and current measurements of each individual supercapacitive cell 105 during the discharge processes. A liquid regenerated TCHP 100 volume of about 2,778 cm³ was used as a basis for the calculations. The effective energy storage density of the prototype as shown in FIG. 2 based on the total supercapacitive cell 105 fixture volume was observed to increase from about 110 mJ cm⁻³ to about 135 mJ cm⁻³ with decreasing applied currents. This trend was likely due to decreasing ohmic resistance at lower applied currents and thus increasing the depth of charge. Average supercapacitive cell 105 electrical round-trip efficiencies ranging from approximately 84.7% to approximately 67.6% were measured across the applied current range from about 25 mA to about 300 mA, respectively. A peak electrical energy storage density of approximately 133.5 mJ cm⁻³ was observed at a discharge current of about 25 mA (see FIG. 3D). The cooling power density was calculated using the cooling delivered divided by the total time of the heat pump test and the total prototype volume. Because the operation time scaled nearly linearly with the applied current, the duration of tests at lower applied currents were much longer than those at higher applied currents. This led to the observed thermal power at lower currents being much lower than those at higher currents. A peak thermal power density of about 13.2 μW cm⁻³ was observed at an applied current of approximately 200 mA (see FIG. 3D).

A liquid regenerator TCHP 100 using deionized water as the fluid 145 was utilized to achieve a temperature drop of approximately 0.24 K at a COP_{c} of about 0.27 with the ability to provide an electrical energy storage density of approximately 133.5 mJ cm⁻³. The small temperature lifts observed were primarily a result of the small adiabatic temperature changes produced by the commercial supercapacitive cells 105 used in the prototype (shown in FIG. 2).

In some embodiments, the working principle of thermocapacitive heating and cooling is based on electric double layer capacitors (EDLCs). Slow charging of a thermocapacitive cell electrostatically binds ions to their electrode surface, forming electric double layer (EDL). The EDL consists of inner Helmholtz layer (IHL), outer Helmholtz layer (OHL), and diffusion layer (DL). The IHL is a compact layer that accumulates the counterions near the porous electrodes, whereas the OHL and DL are the extension of the IHL that contains movable ions affected by electrostatic forces and diffusion.

The formation of those layers decreases ionic configuration entropy (Sᵢₒₙ) due to the reduced disorder of ions within the bulk electrolyte. This may be counterbalanced by increasing the electrolyte entropy and cell temperature (i.e., reversible heating) based on the second law of thermodynamics, i.e., dS=0. Slow discharging of the cell desorbs ions from the electrode surface, decreasing the electrolyte entropy and cell temperature (i.e., reversible cooling).

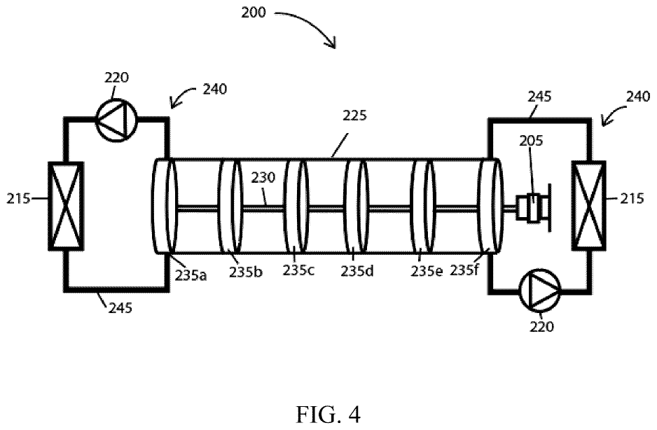

FIG. 4 illustrates a solid regenerated TCHP 200 with multiple supercapacitive cells 235a-f, according to some aspects of the present disclosure. The solid regenerated TCHP 200 includes a plurality of supercapacitive cells 235a-f which are arranged in a series on a shaft 230. The shaft 230 can be rotated or moved with an actuator 205. The plurality of supercapacitive cells 235 may be contained in a container 225. On each end of the plurality of supercapacitive cells 235 there is a fluid circuit 240 containing a fluid 245. Each fluid circuit 240 may have a pump 220 and a heat exchanger 215. The first heat exchanger 215 may be configured to release heat and the second heat exchanger 215 may be configured to the absorb heat. That is, the heat may primarily be directed (or flow towards) the first fluid circuit 240 and away from the second fluid circuit 240.

The solid regenerated TCHP 200 is very similar to the liquid regenerated TCHP 100 in many ways. The primary difference between the solid regenerated TCHP 200 and the liquid regenerated TCHP 100 is the medium through which the heat is transferred (a centralized fluid circuit 140 in the liquid regenerated TCHP 100 vs a plurality of supercapacitive cells 235 in the solid regenerated TCHP 200).

In some embodiments, the supercapacitive cells 235a-f transfer the heat to the forward x-direction by alternating the charged and discharged supercapacitive cells 235 by: 1) Adiabatic charging: Even index supercapacitive cells 235b, 235d, and 235f charge (i.e., heat up) while odd index supercapacitive cells 235a, 235c, and 235e discharge (i.e., cool down). 2) Heat rejection at q_{H}: Even index supercapacitive cells 235b, 235d, and 235f contact adjacent odd supercapacitive cells 235a, 235c, and 235e with higher index to transfer heat in x-direction. 3) Adiabatic discharging: Even index supercapacitive cells 235b, 235d, and 235f discharge (i.e., cool down) while odd index supercapacitive cells 235a, 235c, and 235e charging (i.e., heat up). 4) Heat absorption at q_{L}: Even index supercapacitive cells 235b, 235d, and 235f contact adjacent odd supercapacitive cells 235a, 235c, and 235e with lower index to transfer heat in x-direction.

Hot and cold side heat exchangers 215 (akin to heater 110 and cooler 115 in FIG. 1) are placed at the opposite ends of each fluid circuit 240 to harness the warmer fluid 245 leaving the supercapacitive cells 235 for heating and the cooler fluid 245 leaving the supercapacitive cells 235 for cooling. Two liquid pumps 220 are used to drive fluid 245 circulation. Electrical charge can be stored in the supercapacitive cells 235 when the heat pump 220 is turned off and used as needed.

To evaluate the embodiment shown in FIG. 4, a cascaded cell system model was used to evaluate the influence of multiple supercapacitive cells 235 on the overall temperature lifts. For model validations, a prototyped symmetric cell with approximately 1 M LiCl aqueous electrolyte was used to examine the accuracy of the simplified cell model used in the solid regenerated TCHP 200 model.

FIG. 5A summarizes the result of comparison between the projected amount of reversible heat delivered (Qᵣₑᵥ), C, and ΔTₛₚₐₙ with calorimetry data. The data was obtained from one charging and discharging cycle based on a supercapacitive cell 235. Each parameter was normalized with each average experimental value. The U of 1 W m−2° C.−1 was assumed to simulate the well-insulated unit operating at ambient temperature. The MAEs of Qᵣₑᵥ, C, and ΔTₛₚₐₙ are approximately 0.04 J, approximately 0.09 F, and approximately 0.09° C., respectively. This indicates that the cell model can reasonably represent the performance of the supercapacitive cell 235 in the cascaded system (i.e., the solid regenerated TCHP 200).

FIG. 5B shows a contour plot representing the influence of the number of supercapacitive cells 105 (N_{cell}) and repeated cycles (N_{cycle}) on the ΔTₛₚₐₙ. The ranges of N_{cell} and N_{cycle} are determined from a solid regenerated TCHP 200 with multiple supercapacitive cells 235. The supercapacitive cell 235 geometries and material properties are obtained from the prototyped LiCl cells. The peak ΔTₛₚₐₙ is nearly 7° C. at approximately 12.5 A m⁻² when the nine cell and cycles are used. This is because the larger regenerator with the higher cycle frequency can deliver more heat from a cold to a hot side cell than a unit cell, enhancing ΔTₛₚₐₙ. For example, ΔTₛₚₐₙ of the nine cascaded cells is approximately 2.2 times higher than that of the three cascaded cells.

FIG. 5C displays the time evolution of the adiabatic ΔTₛₚₐₙ and cell temperatures at approximately 12.5 A m⁻² based on the nine supercapacitive cells 235 and cycles selected. The ΔTₛₚₐₙ is monotonically increasing as a result of the movement of heat from cold to hot cells during cycling. The peak adiabatic ΔTₛₚₐₙ is found to be nearly 2,500 s, corresponding to the last cycle. The increase in the ΔTₛₚₐₙ per cycle is due to the increase in the temperature swing of a cold thermocapacitive cell 235 that is contacted with a thermal reservoir of 30° C. as shown in the solid line of the plot.

FIG. 5D presents that the supercapacitive cells 235 in series are cycled through the cell fixture between two fluid circuits 240 to gradually build up a temperature difference between the fluid circuits 245. The cold-and hot-side supercapacitive cell 235 temperatures are shown in the left and right end of the plots, respectively. It is clear that the hot supercapacitive cell 235 temperature increases significantly with relative to the cold cell for a given current density. The larger magnitude of temperature distribution across the cascaded cells can be achieved at the higher N_{cycle} when maintaining adiabatic condition.

FIG. 5E shows the influence of current density on the thermal and energy storage performance of a nine cascaded supercapacitive cell 235 system. Each marker represents ΔTₛₚₐₙ and energy storage densities (ED) respectively which are both a function of heating density (\dot{q}ᵥ). It is clear that ΔTₛₚₐₙ and ED decrease with increasing heating density. This is a classic tradeoff between capacity and temperature lift in caloric cooling and heating devices.

On the right end of the performance curve, the data shows the maximum \dot{q}ᵥ of approximately 15 kW m⁻³ at the minimum ΔTₛₚₐₙ of approximately 5° C. and ED of approximately 0.3 kWh m⁻³. On the left end of the plot, slower charging/discharging will increase the overall Tₛₚₐₙ by up to approximately 12.1° C. and ED of approximately 0.83 kWh m−3. The decrease in capacity at lower current densities is attributed to the increased cycling time which is more significant than the rise in ΔTₛₚₐₙ.

Faster charging/discharging will increase system capacity associated with reversible heating in the cell due to the reduced cycling time, but it will also increase irreversible ohmic heat generation. An ideal system would utilize cells with lower ohmic losses and larger reversible heat. This would reduce the cycling time and associated heat losses to increase the \dot{q}ᵥ. For example, the solid regenerated TCHPs 200 may provide a potential \dot{q}ᵥand ΔTₛₚₐₙ increase of over approximately 30% when the supercapacitive cell 235 resistance is reduced by approximately 50% and thermopower is enhanced by approximately 50% with relative to the prototyped cells.

FIG. 5F shows a performance map for a solid generated TCHP 200 cycle in terms of the second law efficiency (also called exergy efficiency, COP/COP_{Carnot}) as a function of current density. The solid regenerated TCHP 200 can achieve the highest second law efficiency at the lowest current density. The expected peak COP/COP_{Carnot} is approximately 0.08 (i.e., COP of approximately 2) based on prototyped LiCl aqueous supercapacitive cells 235 (markers). The drop in the system efficiency with increasing the current densities is due to Joule heating, which accounts for approximately 96.5% of total heating at approximately 16.6 A m⁻². The monotonic increase in \dot{q}ᵥ at higher current densities is due to the greater impacts of reduced cycling time than that of the decrease in ΔTₛₚₐₙ. An optimal current density would be the range of current densities from approximately 8.3 A m⁻² to approximately 10 A m⁻² that can achieve heating density of approximately 6-8 kW m⁻³ with relatively high COP/COP_{Carnot} of approximately 0.1-0.3.

The second law efficiency theoretically reaches up to approximately 0.33 as long as the cell achieves two-fold increases in both the _{aC} and αᵣₑᵥ. Fabricating cells with larger aC and αᵣₑᵥ would be possible due to the recent advancements in supercapacitive cells 235. The ED of the supercapacitors can reach as high as approximately 60-88 kWh m⁻³, which is 10 times higher than that of the prototyped LiCl aqueous supercapacitive cells 235. This means the cell has potential to enhance aC by a factor of 10. Moreover, an iron-based electrolyte design strategy using a binary solvent and anion engineering produces a high αᵣₑᵥ of approximately 3.73 mV ° C.⁻¹, which is 2-3 times higher than that of the prototyped ones.

The solid regenerated TCHP 200 has potential to achieve high second law efficiency while producing comparable ΔTₛₚₐₙ, ₘₐₓ to the other caloric devices. Leveraging the prototyped LiCl aqueous cells in a cascaded manner, the projected ΔTₛₚₐₙ, ₘₐₓ is approximately 12° C. and \dot{q}ᵥis approximately 15 kW m⁻³, both at the U of 1 W m⁻² ° C.⁻¹. This ΔT_{span,max} is comparable to that of electrocaloric devices based on multilayer capacitors, higher than that of magnetocaloric devices showing approximately 5.9° C. to approximately 11° C., and superior to that in electrochemical devices showing ΔT_{span,max} less than 1° C. If the aC and αᵣₑᵥ of the LiCl cell can be doubled, ΔT_{span,max} could theoretically be reached up to nearly 30° C. with COPₘₐₓ/COP_{Carnot} of approximately 0.33 at approximately 8.3 A m⁻². Those projected performance supersedes most of the other caloric and electrochemical heat pumps.

Enhancing ΔT_{span,max} for the solid regenerated TCHPs 200 requires (i) the optimization of the electrode microstructure and composition to increase ion storage capacity and incorporate redox reactions into the charge storage process, (ii) increase in the thermopower of enclosed electrochemical cells by changing solvation entropy, and (iii) optimization of system architectures to maximize heat transfers and internal heat recuperation for high-efficiency hybrid solid regenerated TCHP 200 and storage. Given the fact that the comparisons are based on the EDₘₐₓ of the solid regenerated TCHPs 200 that are an order of magnitude lower than that of the ASHP and PCM energy storage technologies, there are significant potential remains to improve the performance of the solid regenerated TCHPs 200. Breakthroughs in both materials and cell designs would allow supercapacitive cells 235 to enable usable heat pumping devices.

In some embodiments, a characteristic of solid regenerated TCHPs 200 is to integrate energy storage processes with heating and cooling components. Such hybridization strategies are fundamentally different from most emerging heat pumping equipment which are mostly single-function thermal devices for moving or transferring heat. By making use of multifunctional devices, the future cooling and heating systems may provide increased utility and load flexibility. This could be beneficial to advanced building cooling and heating and other thermal management applications as energy storage becomes increasingly important for energy system integration.

In some embodiments, the solid regenerated TCHP 200 includes supercapacitive cell 235 designs that enable larger adiabatic temperature spans for heat pumping applications. To this end, pouch type supercapacitive cells 235 were prototyped and modeled, and tested using a micro-calorimeter. The cell-level experimental results were combined with the solid regenerated TCHP 200 cycle model to evaluate the influence of multiple supercapacitive cells 235 on the overall temperature span.

In some embodiments, the activated carbon-based supercapacitive cells 235 (approximately 24.08 cm²) with 1 M LiCl aqueous electrolyte produce higher reversible heat and capacitance than those with other mixed solvent electrolytes. The supercapacitive cells 235 have the averaged pore size of 1.5 μm, low Bi of 0.01, and high D_{th,eff} of 0.145 cm² s⁻¹. Based on the low Bi and D_{th,eff} of the supercapacitive cells 235, the lumped-element model and quasi-steady state approximation can be used to predict the supercapacitive cell 235 temperature.

In some embodiments, the measured q_{\dot{T},rev}s are symmetric exothermic and endothermic processes. The heat energy produced during charging and discharging cycles is recovered when the process is reversed. The peak reversible q_{\dot{T},rev} decreases from approximately 3.8 W m⁻² to approximately 1.6 W m⁻² at higher currents due to the reduced capacitance from 5.8 F to 3.5 F. This corresponds to the decrease in the averaged αᵣₑᵥ from −1.7 mV ° C.⁻¹ to −0.65 mV ° C.⁻¹. The faster charging and discharging leave more unused area and energy in the supercapacitive cells 235, decreasing the electrolyte Δs from approximately 45.5 J kg⁻¹ ° C.⁻¹ to approximately 1.7 J kg⁻¹ ° C.⁻¹ and thus reduced q_{\dot{T},rev} and αᵣₑᵥ.

In some embodiments, the change in LiCl supercapacitive cell 235 temperature is strongly affected by U values. When U is 1 W m⁻² ° C.⁻¹, ΔTₛₚₐₙ is approximately 0.9° C. to approximately 2.7° C. When U is 5 W m⁻² ° C.⁻¹, ΔTₛₚₐₙ is approximately 0.57° C. to approximately 0.22° C. Those ΔTₛₚₐₙ are less than approximately 0.03° C. when U is 100 W m⁻² ° C.⁻¹. The decrease in ΔTₛₚₐₙ at higher U is a result of larger heat losses to the ambient. The maximum temperature span of approximately 2.7° C. at the U of approximately 1 W m⁻² ° C.⁻¹ of the LiCl supercapacitive cells 235 is higher than that of other reported cells designed less than 100° F.

In some embodiments, the faster charging and discharging increase the ratio of Joule heating to total heating from approximately 58% to approximately 96.5%. To reduce the Joule heating and improve the ΔTₛₚₐₙ of the supercapacitive cells 235, it is important to reduce the cell ohmic resistance. Moreover, the supercapacitive cell 235 provides a potential ΔTₛₚₐₙ increase of over 50% by reducing mcₚ and improving αᵣₑᵥ by approximately 50%, respectively. This can be achieved by fabricating thinner electrodes, oxides electrodes that involve Faradaic reactions, binary solvent and anion engineering, and organic electrolytes having 2 times lower density.

In some embodiments, arranging the nine prototyped LiCl supercapacitive cells 235 in a cascade manner, the solid regenerated TCHPs 200 have a potential to produce comparable ΔTₛₚₐₙ to other electrochemical and caloric heat pumping technologies. The maximum ΔTₛₚₐₙ is 12° C. at the U of 1 W m⁻² ° C.⁻¹, and the \dot{q}ᵥis approximately 15 kW m⁻³. This ΔT_{span,max} is comparable to that of electrocaloric devices based on multilayer capacitors. If the C and αᵣₑᵥ of the supercapacitive cells 235 were doubled, the COPₘₐₓ/COP_{Carnot} could reach up to approximately 0.33. The projected performance supersedes those of the other caloric and electrochemical heat pumps.

In some embodiments, achieving comparable ΔT_{span,max} for solid regenerated TCHPs 200 relative to commercially available heat pump systems is still challenging, the thermocapacitive effects have a significant potential regarding heating power density. This is because the solid regenerated TCHPs 200 store electrical energy electrostatically, which allows for very rapid charging and discharging as well as delivering heat. One of the potential applications for the solid regenerated TCHPs 200 could be a combination heat pump system in residential buildings, which requires large and rapid transitions of refrigerant temperatures and heating capacity.

In some embodiments, the solid regenerated TCHPs 200 could be beneficial to the development of advanced building cooling and heating systems as energy storage becomes increasingly important for energy system integration. To advance the solid regenerated TCHP 200, the recommended future research directions are (i) the optimization of the electrode microstructure and composition to increase ion storage capacity and incorporate redox reactions into the charge storage process, (ii) increase in the thermopower of enclosed electrochemical/supercapacitive cells 235 by changing solvation entropy, and (iii) optimization of system architectures to maximize heat transfers and internal heat recuperation for high-efficiency hybrid solid regenerated TCHP 200 and energy storage.

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations, may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. A device comprising:
a supercapacitive cell;
a voltage source configured to supply a voltage to the supercapacitive cell;
a first reservoir;
a second reservoir;
a first heat exchanger configured to release heat;
a second heat exchanger configured to absorb heat; and
a fluid circuit positioned through the supercapacitive cell, the first reservoir, the second reservoir, the first heat exchanger, and the second heat exchanger; wherein:
a fluid is present is the fluid circuit, and
when the voltage is applied to the supercapacitive cell the supercapacitive cell is configured to generate a temperature difference between the first reservoir and the second reservoir.

2. The device of claim 1, further comprising:
a pump; wherein:
the pump is configured to pump the fluid through the fluid circuit.

3. The device of claim 1, wherein:
the supercapacitive cell comprises:
a supercapacitor.

4. The device of claim 1, wherein:
the supercapacitive cell is configured to heat a portion of the fluid when the voltage is applied, resulting in a heated fluid, and
the heated fluid is configured to flow into the first reservoir.

5. The device of claim 1, wherein:
the supercapacitive cell is configured to cool a portion of the fluid when the voltage is reduced, resulting in a cooled fluid, and
the cooled fluid is configured to flow into the second reservoir.

6. The device of claim 1, wherein:
the fluid comprises water.

7. The device of claim 1, further comprising:
a second supercapacitive cell; wherein:
the supercapacitive cell is a first supercapacitive cell, and
the first supercapacitive cell and the second supercapacitive cell are arranged in series.

8. The device of claim 1, wherein:
the first heat exchanger is configured to release heat to a building.

9. The device of claim 1, wherein:
the second heat exchanger is configured to absorb heat from a building.

10. A method comprising:
operating a thermocapacitive heat pump; wherein:
the thermocapacitive heat pump comprises:
a supercapacitive cell;
a voltage source configured to supply a voltage to the supercapacitive cell;
a first reservoir;
a second reservoir;
a first heat exchanger configured to release heat;
a second heat exchanger configured to absorb heat; and
a fluid circuit positioned through the supercapacitive cell, the first reservoir, the second reservoir, the first heat exchanger, and the second heat exchanger; wherein:
the operating comprises applying a voltage to the supercapacitive cell resulting in the supercapacitive cell generating a temperature difference between the first reservoir and the second reservoir.

11. A device comprising:
a plurality of supercapacitive cells;
a voltage source configured to supply a voltage to the supercapacitive cells;
a first fluid circuit connecting at least one of the supercapacitive cells to a first heat exchanger; and
a second fluid circuit connecting at least one of the supercapacitive cells to a second heat exchanger; wherein:
when the voltage is applied to the supercapacitive cells the supercapacitive cells are configured to generate a temperature difference between the first fluid circuit and the second fluid circuit.

12. The device of claim 11, further comprising:
a first pump; wherein:
the pump is configured to pump the fluid through the first fluid circuit.

13. The device of claim 11, further comprising:
a second pump; wherein:
the pump is configured to pump the fluid through the second fluid circuit.

14. The device of claim 11, wherein:
the plurality of supercapacitive cells comprise:
a shaft configured to align the supercapacitive cells; and
an actuator configured to move the shaft.

15. The device of claim 11, wherein:
when a voltage is applied the plurality of supercapacitive cells are configured to direct heat in a first direction resulting in a heated first fluid circuit, and
the first heat exchanger is configured to release heat from the first fluid circuit.

16. The device of claim 15, wherein:
the first exchange is in thermal communication with an interior of a building.

17. The device of claim 11, wherein:
the fluid comprises water or a refrigerant.

18. The device of claim 11, wherein:
the plurality of thermocapacitive cells are arranged in series in a channel with spacing between each thermocapacitive cell to facilitate a temperature gradient formation across the channel.

19. The device of claim 18, wherein:
the channel comprises a first end and a second end,
the first fluid circuit is in thermal communication with the first end, and
the second fluid circuit is in thermal communication with the second end.

20. The device of claim 10, wherein:
the second exchanger is in thermal communication with a building interior,
the second heat exchanger is configured to absorb heat and transfer it to the second fluid circuit,
the second fluid circuit is in thermal communication with the supercapacitive cells.
